(19) United States
(12) Patent Application Publication
(10) Pub. No.: US 2016/0260141 A1
(43) Pub. Date: Sep. 8, 2016

(54) Communication Method, User Device, Content Server and Controller

(71) Applicant: Huawei Technologies Co., Ltd., Shenzhen (CN)

(72) Inventors: Shaobo Zhang, Shenzhen (CN); Peiyun Di, Shenzhen (CN)

(21) Appl. No.: 15/159,095

(22) Filed: May 19, 2016

Related U.S. Application Data
(63) Continuation of application No. PCT/CN2014/073043, filed on Mar. 7, 2014.

(51) Int. Cl. G06Q 30/02; H04L 29/08; H04L 29/06

(52) U.S. Cl. CPC G06Q 30/0277; H04L 65/4084; H04L 67/02; H04L 63/0428; H04L 63/10

(57) ABSTRACT

A communication method, a user device, a content server and a controller are provided. The communication method comprises sending a first access request for a segment of depended content to a content server, wherein the depended content comprises at least one segment, receiving an access receipt from the content server, wherein the access receipt contains information describing present access to the segment of the depended content by a user device, and storing the access receipt such that the control capability of the network on behavior of the user device is enhanced while reserving enough flexibility of the user device.

### CROSS-REFERENCE TO RELATED APPLICATIONS

This application is a continuation of International Application No. PCT/CN2014/073043, filed on Mar. 7, 2014, which is hereby incorporated by reference in its entirety.

### TECHNICAL FIELD

The present disclosure relates generally to communication technologies, and in particular, to a communication method, a user device, a content server and a controller.

### BACKGROUND

Streaming has become a popular service for multimedia content, e.g. video and audio. Advertisement is an important business model for online streaming services. On a side of a service provider, advertisement is where revenue comes from, and on a side of an end user, he/she is forced to watch a short advertisement that he/she is not interested in, and as a return, other content of a media presentation can be accessed for free. Such a business model of sponsoring online video through an online video advertisement has been established in the media distribution industry. In practice, several factors contribute to the establishment of this eco-system, which includes a content delivery network (CDN), an analytic data provider, an advertisement network and an advertisement exchange platform. Impression and selection of an advertisement are made via the advertisement exchange platform, the selected advertisement is delivered by the CDN, and an analytic tool analyzes completion rate of the advertisement and reports such information to an advertiser.

It is desirable that an advertisement is consumed by an end user. Even if it is difficult to guarantee that the advertisement is watched, it is desired at least not to be skipped, which is referred to as forced playback. The forced playback of an advertisement imposes great challenges for a client driven streaming solution, such as dynamic adaptive streaming over hypertext transfer protocol (DASH) specified by moving picture experts group (MPEG). The challenges come from the inherent characteristics of the client driven streaming solution. Take DASH as an example, it is the client who controls the process of streaming, and a content server sends content to the client on request and does not track the status of the client. In addition, a DASH client is running in an open environment, i.e., on diversified devices, such as a desktop or laptop, a pad, an intelligent mobile phone, etc. Further, DASH is an open standard, and a DASH client implemented as an open source package may be easily modified to behave in a different way from what the service provider expects. For the above-mentioned reasons, in the absence of a trusted DASH client, a non-trusted client usually marks parts of a media presentation as an advertisement and employs various means to bypass the advertisement.

A method referred to as authorized access to dependent content (AAtDC) is proposed on this subject. A fundamental idea of the AAtDC is that authorization is performed before a client accesses dependent content, to which access depends on depended content which includes advertisement content. Generally, an advertisement may be inserted in the front of a media presentation, referred to as pre-roll ad, or inserted in the middle of a media presentation, referred to as mid-roll ad. In the AAtDC, an authorization server selects a set of time-divided parts of the depended content, i.e., segment(s) or sub-segment(s) in a period containing an advertisement in context of DASH, and evidence associated with these time-divided parts are required to be submitted by the client. If the submitted evidence matches, it indicates that the client has downloaded and/or processed the depended content and an access token for accessing the dependent content is assigned to the client. The client may then use the access token to access dependent content. The AAtDC works well for a pre-roll advertisement. However, if the depended content in which an advertisement is included is in the middle of a media presentation followed by the dependent content, a client may do enough look-ahead before getting to the depended content, download the depended content in advance, derive evidence required for authorization and skip the depended content later without watching it when it gets to the playtime of the depended content. Hence, the AAtDC is not a good choice for a mid-roll advertisement.

Another method referred to as control of buffering pace (CoBP) is proposed to overcome the above-mentioned drawback of the AAtDC. In the CoBP, after each part of content is accessed, access authorization is performed and an access token is assigned to a user device for accessing a next part of the content. The access token does not take effect until a predetermined time period elapses. In this way, each part of the content can only be accessed after a period of time that the previous part of the content is accessed, which avoids possible cheating behavior where a client downloads the content too fast and before it is consumed. The CoBP is applicable to both pre-roll advertisement and mid-roll advertisement. However, the CoBP does not support random seeking and trick mode operation on content being not dependent. At the present, how to reconstruct behavior of a client on a network side and how to implement forced playback are still problems for a client driven streaming solution such as DASH.

### SUMMARY

The present disclosure provides a communication method, a user device, a content server and a controller, aiming at solving the above-mentioned problems in implementing forced playback in a client driven streaming system.

In a first aspect, a communication method is provided, including sending a first access request for a segment of depended content to a content server, wherein the depended content includes at least one segment, receiving an access receipt from the content server, wherein the access receipt contains information describing present access to the segment of the depended content by a user device, and storing the access receipt.

In accordance with the first aspect, in a first possible implementation, the information contained in the access receipt includes information on at least one of access time, a segment number, segment uniform resource locator (URL), source address of the access receipt, and destination address of the access receipt.

In accordance with the first aspect or the first possible implementation of the first aspect, in a second possible implementation, the access receipt is encrypted or signed by the content server.

In accordance with the first aspect or the first or second possible implementation of the first aspect, in a third possible implementation, the method further includes sending at least one access receipt stored by the user device to a controller, wherein each of the at least one access receipt contains information describing an access to a segment of the depended content, such that access status information of the user device is determined by the controller according to the at least one access receipt.

In accordance with the third possible implementation of the first aspect, in a fourth possible implementation, the at least one access receipt includes at least one of first M₁ access receipt(s) of access receipt(s) stored by the user device and last M₂ access receipt(s) of the access receipt(s) stored by the user device, wherein M₁ and M₂ are integers equal to or greater than one.

In accordance with the third or fourth possible implementation of the first aspect, in a fifth possible implementation, the access status information of the user device includes information on at least one of a number of times the user device accesses the depended content, which segment of the depended content is accessed by the user device, and time when the user device accesses a segment of the depended content.

In accordance with any one of the third to fifth possible implementations of the first aspect, in a sixth possible implementation, the controller is an authorization server, and sending at least one access receipt stored by the user device to a controller includes sending an authorization request carrying the at least one access receipt to the authorization server, wherein the authorization request is used for requesting authorization for access to dependent content, and wherein the access status information is used to determine whether the authorization request is accepted by the authorization server.

In accordance with the sixth possible implementation of the first aspect, in a seventh possible implementation, the method further includes receiving an access token for accessing the dependent content from the authorization server in response to the authorization request, and sending a second access request for a segment of the dependent content to the content server, wherein the second access request carries the access token.

In a second aspect, another communication method is provided, including receiving a first access request for a segment of depended content from a user device, generating an access receipt according to the first access request, wherein the access receipt contains information describing present access to the segment of the depended content by the user device, and sending the access receipt to the user device.

In accordance with the second aspect, in a first possible implementation, the information contained in the access receipt includes information on at least one of access time, a segment number, segment URL, source address of the access receipt, and destination address of the access receipt.

In accordance with the second aspect or the first possible implementation of the second aspect, in a second possible implementation, the sent access receipt is in a form that any modification to it can be detected by a network side.

In accordance with the second possible implementation of the second aspect, in a third possible implementation, the access receipt is encrypted or signed.

In accordance with the second aspect or any one of the first to third possible implementations of the second aspect, in a fourth possible implementation, the method further includes receiving a second access request for a segment of dependent content from the user device, and determining whether to send the requested segment of the dependent content to the user device.

In accordance with the fourth possible implementation of the second aspect, in a fifth possible implementation, determining whether to send the requested segment of the dependent content to the user device includes determining to send the requested segment of the dependent content to the user device if the second access request carries an access token, and determining not to send the requested segment of the dependent content to the user device if the second access request does not carry an access token.

In accordance with the fourth possible implementation of the second aspect, in a sixth possible implementation, before determining whether to send the requested segment of the dependent content to the user device, the method further includes receiving an authorization indication for indicating whether the user device is authorized to access the dependent content, and determining whether to send the requested segment of the dependent content to the user device includes determining to send the requested segment of the dependent content to the user device if the authorization indication indicates that the user device is authorized to access the dependent content, and determining not to send the requested segment of the dependent content to the user device if the authorization indication indicates that the user device is unauthorized to access the dependent content.

In a third aspect, a communication method is provided, including receiving at least one access receipt from a user device, wherein each of the at least one access receipt contains information describing an access to a segment of depended content by the user device, and determining access status information of the user device according to the at least one access receipt.

In accordance with the third aspect, in a first possible implementation, the information contained in an access receipt of the at least one access receipt includes information on at least one of access time, a segment number, segment URL, source address of the access receipt, and destination address of the access receipt.

In accordance with the third aspect or the first possible implementation of the third aspect, in a second possible implementation, the access status information of the user device includes information on at least one of a number of times the user device accesses the depended content, which segment of the depended content is accessed by the user device, and time when the user device accesses a segment of the depended content.

In accordance with the third aspect or the first or second possible implementation of the third aspect, in a third possible implementation, receiving at least one access receipt from a user device includes receiving an authorization request carrying at least one access receipt from the user device, wherein the authorization request is used for requesting authorization for access to dependent content, and the method further includes determining whether the authorization request is accepted according to the access status information of the user device.

In accordance with the third possible implementation of the third aspect, in a fourth possible implementation, determining whether the authorization request is accepted according to the access status information of the user device includes determining that the authorization request is rejected if the access status information of the user device indicates that at least one of the following conditions is met: a number of segments of the depended content the user device has accessed is less than a threshold number, time interval between two successive accesses to the depended content is shorter than a first threshold time period, time interval between the first access to the depended content and the last access to the depended content is longer than a third threshold time period, time period from the first access to the depended content to sending the authorization request is shorter than a fourth threshold time period, and segments of the depended content are not accessed in an order as appeared in media presentation timeline.

In accordance with the third or fourth possible implementation of the third aspect, in a fifth possible implementation, if it is determined that the authorization request is accepted, the method further includes one of sending an access token for accessing to the dependent content to the user device, and sending an authorization indication for indicating that the user device is authorized to access the dependent content to a content server.

In a fourth aspect, a user device is provided, including a sending unit configured to send a first access request for a segment of depended content to a content server, wherein the depended content includes at least one segment, a receiving unit configured to receive an access receipt from the content server, wherein the access receipt contains information describing present access to the segment of the depended content requested by the first access request sent by the sending unit, and a storing unit configured to store the access receipt received by the receiving unit.

In accordance with the fourth aspect, in a first possible implementation, the information contained in the access receipt includes information on at least one of access time, a segment number, segment URL, source address of the access receipt, and destination address of the access receipt.

In accordance with the fourth aspect or the first possible implementation of the fourth aspect, in a second possible implementation, the access receipt is encrypted or signed by the content server.

In accordance with the fourth aspect or the first or second possible implementation of the fourth aspect, in a third possible implementation, the sending unit is further configured to send at least one access receipt stored by the storing unit to a controller, wherein each of the at least one access receipt contains information describing an access to a segment of the depended content, such that access status information of the user device is determined by the controller according to the at least one access receipt.

In accordance with the third possible implementation of the fourth aspect, in a fourth possible implementation, the at least one access receipt includes at least one of first M₁ access receipt(s) of access receipt(s) stored by the user device and last M₂ access receipt(s) of the access receipt(s) stored by the user device, wherein M₁ and M₂ are integers equal to or greater than one.

In accordance with the third or fourth possible implementation of the fourth aspect, in a fifth possible implementation, the access status information of the user device includes information on at least one of a number of times the user device accesses the depended content, which segment of the depended content is accessed by the user device, and time when the user device accesses a segment of the depended content.

In accordance with any one of the third to fifth possible implementations of the fourth aspect, in a sixth possible implementation, the controller is an authorization server, and the sending unit is further configured to send an authorization request carrying the at least one access receipt to the authorization server, wherein the authorization request is used for requesting authorization for access to dependent content, and wherein the access status information is used to determine whether the authorization request is accepted by the authorization server.

In accordance with the sixth possible implementation of the fourth aspect, in a seventh possible implementation, the receiving unit is further configured to receive an access token for accessing the dependent content from the authorization server in response to the authorization request sent by the sending unit, and the sending unit is further configured to send a second access request for a segment of the dependent content to the content server, wherein the second access request carries the access token received by the receiving unit.

In a fifth aspect, a content server is provided, including a receiving unit configured to receive a first access request for a segment of depended content from a user device, a generating unit configured to generate an access receipt according to the first access request received by the receiving unit, wherein the access receipt contains information describing present access to the segment of the depended content by the user device, and a sending unit configured to send the access receipt generated by the generating unit to the user device.

In accordance with the fifth aspect, in a first possible implementation, the information contained in the access receipt includes information on at least one of access time, a segment number, segment URL, source address of the access receipt, and destination address of the access receipt.

In accordance with the fifth aspect or the first possible implementation of the fifth aspect, in a second possible implementation, the access receipt sent by the sending unit is in a form that any modification to it can be detected by a network side.

In accordance with the second possible implementation of the fifth aspect, in a third possible implementation, the access receipt is encrypted or signed.

In accordance with the fifth aspect or any one of the first to third possible implementations of the fifth aspect, in a fourth possible implementation, the receiving unit is further configured to receive a second access request for a segment of dependent content from the user device, and the content server further includes a determining unit configured to determine whether to send the segment of the dependent content requested by the second access request received by the receiving unit to the user device.

In accordance with the fourth possible implementation of the fifth aspect, in a fifth possible implementation, the determining unit is further configured to determine to send the requested segment of the dependent content to the user device if the second access request received by the receiving unit carries an access token, and determine not to send the requested segment of the dependent content to the user device if the second access request received by the receiving unit does not carry an access token.

In accordance with the fourth possible implementation of the fifth aspect, in a sixth possible implementation, the receiving unit is further configured to receive, before the determining unit determines whether to send the requested segment of the dependent content to the user device, an authorization indication for indicating whether the user device is authorized to access the dependent content, and the determining unit is further configured to determine to send the requested segment of the dependent content to the user device if the authorization indication received by the receiving unit indicates that the user device is authorized to access the dependent content, and determine not to send the requested segment of the dependent content to the user device if the authorization indication received by the receiving unit indicates that the user device is unauthorized to access the dependent content.

In a sixth aspect, a controller is provided, including a receiving unit configured to receive at least one access receipt from a user device, wherein each of the at least one access receipt contains information describing an access to a segment of depended content by the user device, and a determining unit configured to determine access status information of the user device according to the at least one access receipt received by the receiving unit.

In accordance with the sixth aspect, in a first possible implementation, the information contained in an access receipt of the at least one access receipt includes information on at least one of access time, a segment number, segment URL, source address of the access receipt, and destination address of the access receipt.

In accordance with the sixth aspect or the first possible implementation of the sixth aspect, in a second possible implementation, the access status information of the user device determined by the determining unit includes information on at least one of a number of times the user device accesses the depended content, which segment of the depended content is accessed by the user device, and time when the user device accesses a segment of the depended content.

In accordance with the sixth aspect or the first or second possible implementation of the sixth aspect, in a third possible implementation, the receiving unit is further configured to receive an authorization request carrying at least one access receipt from the user device, wherein the authorization request is used for requesting authorization for access to dependent content, and the determining unit is further configured to determine whether the authorization request received by the receiving unit is accepted according to the access status information of the user device.

In accordance with the third possible implementation of the sixth aspect, in a fourth possible implementation, the determining unit is further configured to determine that the authorization request is rejected if the access status information of the user device indicates that at least one of the following conditions is met a number of segments of the depended content the user device has accessed is less than a threshold number, time interval between two successive accesses to the depended content is shorter than a first threshold time period, time interval between the first access to the depended content and the last access to the depended content is longer than a third threshold time period, time period from the first access to the depended content to sending the authorization request is shorter than a fourth threshold time period, and segments of the depended content are not accessed in an order as appeared in media presentation timeline.

In accordance with the third or fourth possible implementation of the sixth aspect, in a fifth possible implementation, if the determining unit determines that the authorization request is accepted, the controller further includes a sending unit configured to: send an access token for accessing the dependent content to the user device, and send an authorization indication for indicating that the user device is authorized to access the dependent content to a content server.

Based on the foregoing technical solutions of the present disclosure, the content server sends an access receipt to the user device upon receiving an access request for a segment of the depended content from the user device, and the access receipt contains information describing the present access to the segment of the depended content. In this way, the user device may send at least one access receipt to a controller, behavior of the user device on the depended content may be reconstructed by the controller according to the at least one access receipt, and subsequent behavior of the user device may be controlled by the controller according to the reconstructed behavior of the user device, for instance, the controller may determine whether the behavior of the user device on the depended content is desirable, and further to determine whether the user device is authorized to access the dependent content, thus enhancing control capability of the network on behavior of the user device while reserving enough flexibility of the user device.

### BRIEF DESCRIPTION OF DRAWINGS

To illustrate the technical solutions in the embodiments of the present disclosure more clearly, a brief introduction on the accompanying drawings needed in the description of the embodiments is given below. The accompanying drawings in the description below are merely some examples of the present disclosure, based on which other drawings may also be obtained by those of ordinary skill in the art without any inventive efforts.

FIG. 1 illustrates an exemplary arrangement of a conventional DASH system;

FIG. 2 illustrates an exemplary arrangement of a DASH system in the present disclosure;

FIG. 3 is a flowchart of a communication method provided by the present disclosure;

FIG. 4 illustrates an exemplary media presentation with timeline with respect to forced playback;

FIG. 5 is a flowchart of another communication method provided by the present disclosure;

FIG. 6 is a flowchart of another communication method provided by the present disclosure;

FIG. 7 is a flowchart of another communication method provided by the present disclosure;

FIG. 8 illustrates an example structure of a user device provided by the present disclosure;

FIG. 9 illustrates an example structure of a content server provided by the present disclosure;

FIG. 10 illustrates an example structure of a controller provided by the present disclosure;

FIG. 11 illustrates an example structure of another user device provided by the present disclosure;

FIG. 12 illustrates an example structure of another content server provided by the present disclosure; and

FIG. 13 illustrates an example structure of another controller provided by the present disclosure.

### DESCRIPTION OF EMBODIMENTS

Hereinafter, a clear and complete description of technical solutions of the embodiments of the present disclosure will be given below, in combination with the accompanying drawings in the embodiments of the present disclosure. The embodiments described below are merely a part, but not all, of the embodiments of the present disclosure. All of the other embodiments, obtained by those skilled in the art based on the embodiments of the present disclosure without any inventive efforts, fall within the protection scope of the present disclosure.

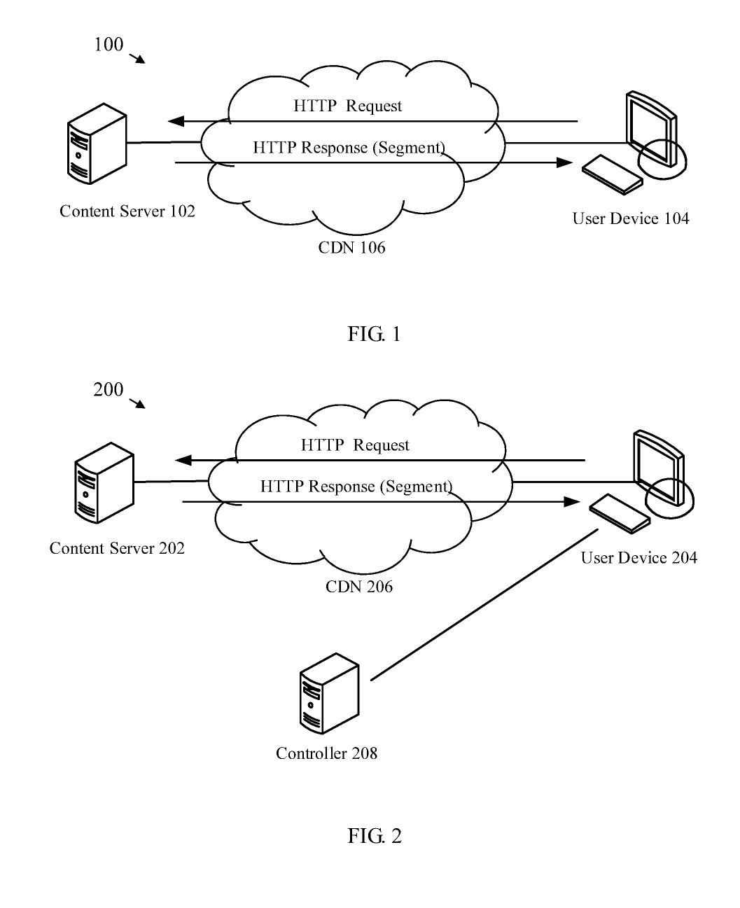

FIG. 1 illustrates an exemplary arrangement of a conventional DASH system 100.

Referring to FIG. 1, the DASH system 100 includes a content server 102, at least one user device 104 and a CDN 106. The content server 102 is responsible for providing content to the at least one user device 104. The user device 104 sends a hypertext transfer protocol (HTTP) request for a segment of a media presentation to the content server 102 via the CDN 106, and the content server 102 sends an HTTP response containing the requested segment to the user device 104 via the CDN 106. The user device 104 can decide which segment to request according to a media presentation description (MPD) file, e.g., an extensible markup language (XML) file, which contains information describing a media presentation, such as period(s) contained in the media presentation, representation(s) included in each period, segment(s) included in each representation and so forth.

A period represents a time interval of content, and a period includes at least one representation of the content within the time interval. Each representation within a period includes at least one time-divided part of the content, i.e., at least one segment or sub-segment. Content of a media presentation in different periods may have different properties, e.g. encoding configuration, media component, number of representations, language, etc. Thus a period corresponds to a content passage.

DASH enables two pieces of content to be spliced in two manners: 1) two pieces of content are treated as two parts of a content passage, which is then prepared to generate representations and is assigned to a period. Segments in the content passage are numbered consecutively, and 2) two pieces of content are taken as two content passages and prepared separately, possibly with different manners, e.g. encoding, bitrates, multiplexing, etc., and assigned to consecutive periods. Both manners can be used for advertisement insertion. Compared with the former, the latter manner provides more flexibility, in particular for advertisement insertion, e.g. advertisement customization and dynamic decision about the advertisement to be inserted. The present disclosure can be applied to both scenarios. In addition, it should be noted that the present disclosure is illustrated with an example of a DASH system, however, the present disclosure can also be applied to other client driven streaming systems, and no limitation is set herein.

FIG. 2 depicts an exemplary arrangement of a DASH system 200 of the present disclosure. Referring to FIG. 2, the DASH system 200 includes a content server 202, at least one user device 204, a CDN 206 and a controller 208.

Function of the content server 202 is similar to that of the content server 102, except that the content server 202 sends an access receipt to a user device 204 upon receiving an access request for a segment of depended content, while if an access request for a segment of dependent content is received, response of the content server 202 depends on judgment of the controller 208 based on behavior of the user device 204. Further, the user device 204 may send at least one access receipt received to the controller 208, and the controller 208 determines behavior of the user device 204 according to the at least one access receipt and judges if the behavior of the user device 204 is acceptable in accordance with a predetermined rule. If the controller 208 determines that the behavior of the user device 204 is acceptable, the user device 204 is authorized to access the dependent content, otherwise, the user device 204 is unauthorized to access the dependent content.

It should be appreciated that, the term “depended content” refers to a part of content in a media presentation, e.g., a period, one or more segments in a period in context of DASH, etc., access to which is a precondition for access to other parts of content in the media presentation. The depended content is typically advertisement content inserted in a media presentation. The term “dependent content” refers to a part of content in a media presentation, access to which is conditional and depends on access to the “depended content”. The dependent content is of a user's (i.e., user-device's) actual interest. Further, the term “accessing a segment” may refer to obtaining the segment, but no limitation is set herein.

In the present disclosure, the user device 204 may be any of a variety of devices, such as a mobile handset, a laptop, a pad, a personal computer (PC), an intelligent mobile phone, a tablet device, a set-up box, a personal digital assistant device, a media player, etc.

The controller 208 may be separated from the content server 202, or alternatively, be the content server 202 per se or be part of the content server 202. No limitation is set herein.

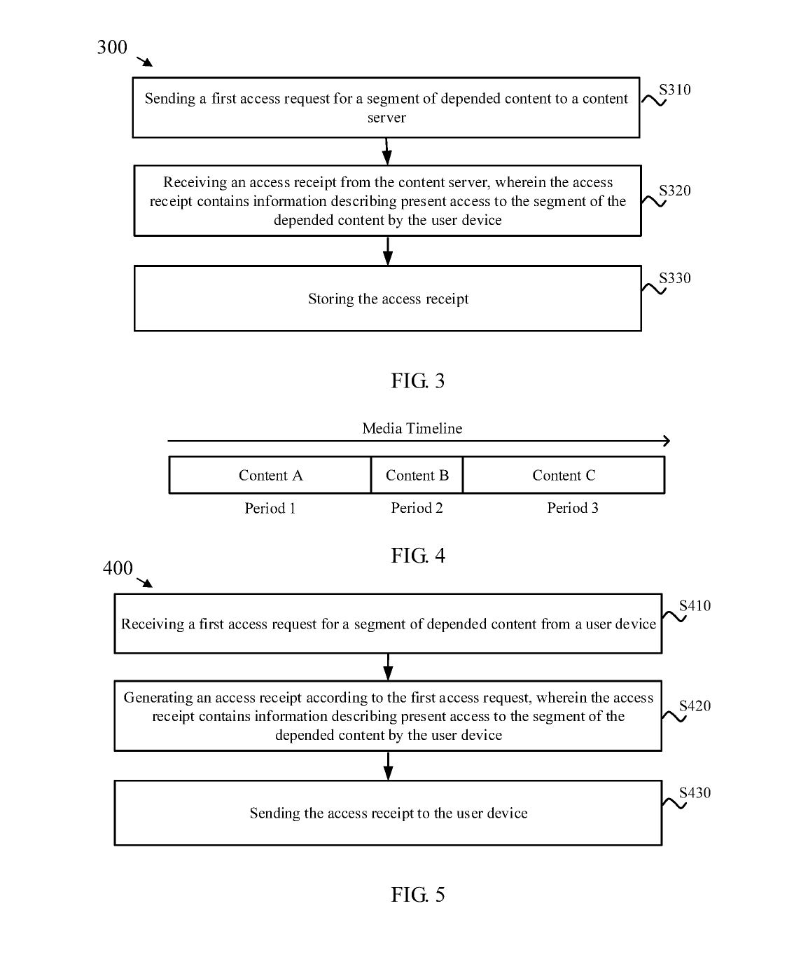

FIG. 3 is a flowchart of a communication method 300 provided by the present disclosure. The communication method 300 may be executed by a user device. Referring to FIG. 3, the communication method 300 includes the following steps.

Step S310: Sending a first access request for a segment of depended content to a content server, wherein the depended content includes at least one segment.

Step S320: Receiving an access receipt from the content server, wherein the access receipt contains information describing present access to the segment of the depended content by the user device.

Step S330: Storing the access receipt.

According to the communication method provided by the present disclosure, the content server sends an access receipt to the user device upon receiving an access request for a segment of the depended content from the user device, and the access receipt contains information describing the present access to the segment of the depended content. In this way, the user device may send at least one access receipt to a controller, behavior of the user device on the depended content may be reconstructed by the controller according to the at least one access receipt, and subsequent behavior of the user device may be controlled by the controller according to the reconstructed behavior of the user device, for instance, the controller may determine whether the behavior of the user device on the depended content is desirable, and further to determine whether the user device is authorized to access the dependent content, thus enhancing control capability of the network on behavior of the user device while reserving enough flexibility of the user device.

Before step S310, the user device may acquire an MPD file of a media presentation and parses the MPD file. The MPD file contains information describing the media presentation, such as information on segments of the media presentation and access dependency relationship of different parts of content included in the media presentation, e.g., which part of the media presentation is depended content and which part of the media presentation is dependent content. In the present disclosure, authorization for accessing the dependent content by a user device depends on access status of the user device to the depended content. The depended content may be advertisement content, and the dependent content may include content which is of the user device's interest, such as content of a drama and the like. For instance, Content A and content C may be two episodes of a drama, content B is advertisement content, and the content B is inserted between the content A and the content C, i.e., an example of a mid-roll advertisement scenario. As shown in FIG. 4, the content A, B and C are respectively contained in periods 1, 2 and 3 of a media presentation. In order for the advertisement to be consumed rather than being skipped, access of a user device to the content C in period 3 depends on access status of the user device to the content B in period 2. In this case, content B is depended content and content C is dependent content. As an alternative, the content A, B and C may be spliced into one period, and access of a user device to the content C depends on access status of the user device to the content B in the same period. The present disclosure does not set limitations on splicing manners of depended content and dependent content.

The user device may determine which segment to consume according to the MPD file and then request the segment. In step S310, the user device requests a segment of depended content by sending the first access request to the content server. The first access is used for requesting to retrieve or access a segment of the depended content. Alternatively, the first access request may include at least one parameter that is necessary for the content server to determine which segment the user device requests and location of the requested segment. The present disclosure does not set limitations on parameters included in the first access request.

Upon receiving the first access request, the content server may generate an access receipt according to the first access request, wherein the access receipt may contain information on the present access of the user device to the requested segment of the depended content. The content server may send the requested segment of the depended content and the access receipt to the user device. Furthermore, the content server may send the requested segment and the access receipt together to the user device, e.g. carried in a response message, or send the requested segment and the access receipt separately in any order, e.g., send the requested segment firstly and then the access receipt, or send the access receipt firstly and then the requested segment. No limitation is set herein.

After receiving the access receipt and the requested segment, the user device may cache the requested segment or directly consume the requested segment, and stores the access receipt for later use. In a preferred embodiment, a network equipment, such as the content server or a controller, is capable of detecting any modification of the access receipt upon receiving it from the user device, and in this case, the user device may stores the access receipt as is received. No limitation is set herein.

In the present disclosure, information contained in the access receipt depends on an operator's needs. In an exemplary embodiment, the access receipt contains information on at least one of access time, a segment number, segment URL, source address of the access receipt, and destination address of the access receipt.

The access time represents time when the user device accesses the requested segment, and further, from the content server's point of view, it may be time when the first access request is received, time when the access receipt is generated, time when the access receipt is sent or the like. The segment number may be the number of the requested segment in the period. The segment URL is used to identify location of the requested segment. The source address of the access receipt is used to identify the content server that issues the access receipt, and the destination address of the access receipt is used to identify the user device that accesses the requested segment. In some aspects of the present disclosure, the access receipt may also contain information that can be used to identify the user device, such as a client identifier and/or the like, such that the user device is prevented from acquiring an access receipt from another user device, and alternatively, the access receipt may contain any other information on an access to the depended content. It should be noted that the above description is merely exemplary, and the access receipt may contain other information according to an operator's needs or a predetermined algorithm, e.g., a period identifier representing a period to which the requested segment belongs, etc. It is preferred that the access time and the segment number are contained in the access receipt, but no limitation is set herein.

An exemplary access receipt contains an identifier of a period to which the request segment belongs, a segment number, access time in universal time coordinated (UTC), and a possible format of the access receipt is as follows:

class receipt {
string period_id;
unsigned int(8) segment_num;
unsigned int(64) access_time;
}

where “access_time” is an integer that declares time at which an access request is received (in unit of seconds since midnight Jan. 1, 1904, in UTC time). The access receipt may be encrypted using Advanced Encryption Standard-128 (AES-128) Counter (CTR) mode without padding. Certainly, other encryption method may also be used, and no limitation is set herein.

In the present disclosure, an access receipt is used for describing an access of the user device to the depended content, and it is expected that the user device does not modify the access receipt after receiving it. However, in some cases, a non-trusted user device would modify the access receipt, whereby an incorrect decision may be made by the network side according to the modified access receipt. In an alternative embodiment, in order to prevent an access receipt from being modified, the content server may generate the access receipt and/or process the access receipt in a way that only network equipment, such as the content server, the controller, and/or the like, can obtain information contained in the access receipt after receiving it. For instance, the access receipt is structured, formatted, signed, encrypted, and/or the like. In this case, if any change is made to an access receipt by the user device, the network side can detect the change upon receiving it from the user device. In the present disclosure, the content server may send the access receipt to the user device as a black-box (e.g. with an unknown structure or format) or as a white-box (e.g. be signed or encrypted). In practice, an operator can define the access receipt and change the structure and/or processing method of the access receipt if needed. No limitation is set herein.

According to the above description, the received access receipt may be in a form that any modification to it can be detected by the network side. In a preferred embodiment, the access receipt is encrypted or signed by the content server.

It should be noted that, in a first scenario where the content server generates an access receipt only when a segment of the depended content is requested, the term “access receipt” in the present disclosure represents an access receipt the user device receives, and alternatively, in a second scenario where the content server generates an access receipt at each time an access request is received regardless of the content being requested, the term “access receipt” in the description hereinafter is intended to mean an access receipt corresponding to the depended content unless specified otherwise or clear from context. For brevity, the present disclosure is illustrated hereinafter by taking the first scenario as an example, but the description is exemplary rather than limiting the present disclosure.

In an alternative embodiment, the user device may send an access receipt stored by the user device to a controller. If the user device receives an access receipt only when it requests a segment of the depended content, number of the access receipts stored by the user device is equal to the number of requests the user device has made for the depended content. Further, an access receipt records an access to the segment of the depended content. Therefore, the controller may determine access status of the user device to the depended content according to the reported access receipt.

If the user device does not request and/or access any segment of the depended content, the number of the access receipt stored by the user device is equal to zero. In this case, the user device may send an indication for indicating that it has no access receipt. Accordingly, the communication method 300 further includes a step of sending an access receipt indication for indicating that the user device has no access receipt to a controller. The controller may determine that the user device has not accessed the depended content yet according to the access receipt indication.

As an alternative, if the user device requests the depended content for at least one time, the user device receives and stores one or more access receipts. In this case, the user device may send a part or all of the stored access receipt(s) to the controller. Accordingly, the method 300 further includes a step of sending at least one access receipt stored by the user device to a controller, wherein each of the at least one access receipt contains information describing an access to a segment of the depended content, such that behavior of the user device on the depended content is determined by the controller according to the at least one access receipt.

The access status information of the client device is used for identifying access status of the user device regarding the depended content, based on which the behavior of the user device on the depended content can be reconstructed. In an exemplary example, the access status information of the user device includes information on at least one of a number of times the user device accesses the depended content, which segment of the depended content is accessed by the user device and time when the user device accesses a segment of the depended content.

The at least one access receipt may include the access receipt corresponding to the first access request. In the present disclosure, the user device may send all of the access receipt(s) it stores, or send a part of the access receipt(s) it stores, for instance, the user device may send the first M₁ access receipt(s) of access receipt(s) stored by the user device and/or the last M₂ access receipt(s) of the access receipt(s) stored by the user device, wherein both M₁ and M₂ are integers equal to or greater than one, or send an access receipt corresponding to specific content or the like. Alternatively, the access receipt(s) stored by the user device may be all access receipt(s) stored by the user device or access receipt(s) stored by the user device since a specific time, e.g., the last sending of at least one access receipt to the controller, but no limitation is set herein. The user device may determine the access receipt(s) to be sent in accordance with a predetermined rule or an instruction from a controller, such as the report instruction or the like. The rule for determining which access receipt(s) to be sent may vary according to purpose of the present sending. For instance, the user device may send the last access receipt it stores if the controller is interested in the time of the last access to the depended content, the user device may send all of the access receipt(s) it stores if the controller is interested in the time interval between two successive accesses to the depended content or interested in the time interval between accesses to two consecutive segments of the depended content, and the user device may send the first access receipt and the last access receipt it stores, etc. if the controller is interested in the time interval between the first access and the last access of the user device to the depended content. No limitation is set herein.

The user device may send the access receipt indication or the at least one access receipt periodically or sporadically, e.g., in accordance with a trigger. Sending of the access receipt indication or the at least one access receipt may be triggered by various conditions, such as on an instruction for the user device to report access status regarding the depended content, but no limitation is set herein. In a preferred embodiment, the user device may send the at least one access receipt it stores when the user device needs to access the dependent content. In this case, the controller is specific to be an authorization server. Accordingly, sending at least one access receipt stored by the user device to a controller includes sending an authorization request carrying the at least one access receipt to the authorization server, wherein the authorization request is used for requesting authorization for access to dependent content.

After the controller receives the at least one access receipt or the access receipt indication sent from the user device, the controller may determine whether the user device has accessed the depended content, whether the user device modifies an access receipt, whether the user device is the owner of an access receipt, etc. Further, with the at least one access receipt reported by the user device, access status information of the client device which is used for identifying access status of the user device regarding the depended content may be obtained, based on which the behavior of the user device on the depended content can be reconstructed. For instance, two sets of behavior parameters may be derived from the at least one access receipt sent by the user device: one is a set of segment numbers, denoted as {nᵢ}, for identifying a segment that has been accessed by the user device, wherein i=1, . . . , A, A being an integer equal to or greater than zero, and wherein nᵢ represents a number of the segment which is accessed by the user device at its i^{th} access to the depended content or at its i^{th} access to the content in media presentation since a specific time, and the other is a set of access time, denoted as {tₙ_{ᵢ}}, for identifying time at which the user device accesses a segment of the depended content, wherein tₙ_{ᵢ} represents access time to the segment numbers nᵢ. As an alternative, the set of access time may be denoted as {tᵢ} with tᵢ denoting time corresponding to the i^{th} access to the depended content. For clarity, the following description is made by assuming that tᵢ denotes time corresponding to the i^{th} access to the depended content, but no limitation is set herein.

According to the two sets of behavior parameters, the controller may determine a number of segments of the depended content that has been accessed by the user device, namely, a value of A, which segment has been accessed by the user device, namely, {nᵢ}, when does the user device access depended content, namely, {tᵢ}, and/or the like. Accordingly, the access status information of the user device includes information on at least one of a number of times the user device accesses the depended content, which segment of the depended content is accessed by the user device and time when the user device accesses a segment of the depended content. Certainly, the controller may determine other access status information according to the at least one access receipt, and no limitation is set herein.

Once the behavior of the user device on the depended content is reconstructed, the controller may judge whether the behavior of the user device is acceptable. In practice, an operator can define different rules to restrict behavior of a user device based on how the operator expects a user device to behave. The rules are deployed in the controller to control behavior of a user device. For instance, a rule, which is employed by the controller to determine whether the behavior of the user device is acceptable, is as follows:

A≧N₁ (1)

tᵢ₊₁−tᵢ≧Δt₁ (2)

T−t₁≧Δt₂ (3)

T−t₁≦Δt₃ (4)

where N₁ denotes a predetermined threshold number of segments, and N₁ is an integer smaller than or equal to a total number of the segments included in the depended content, T denotes time at which the at least one access receipt is received from the user device, i.e., present time, and Δt₁, Δt₂ and Δt₃ denote predetermined thresholds of time period, wherein Δt₁ may take a value less than but comparable to duration of a segment (assuming that duration of each segment is close to equal), Δt₂ may take a value less than but comparable to duration of the depended content (sum of duration of all segments of the depended content), and Δt₃ may take a value greater than but comparable to duration of the depended content, but no limitation is set herein.

The behavior of the user device on the depended content is determined to be acceptable only when all of the above conditions are met. Correspondingly, if any of the above conditions is not met, the behavior of the user device on the depended content is determined to be unacceptable. For instance, if the number of segments of the depended content the user device has accessed is smaller than N₁, or time interval between two successive accesses to the depended content is smaller than Δt₁, or time period from the first access to the depended content to the present time is smaller than Δt₂ or larger than Δt₃, the behavior of the user device on the depended content is determined to be unacceptable. This rule basically requires that at least N₁ segments of the depended content are accessed within a limited time period and successive accesses are not too close. If the user device downloads the depended content in advance, formula (4) is not satisfied, i.e., time from the first access to the depended content and the present time is larger than Δt₃. If the user device downloads the depended content faster than the content is consumed, at least one of formulas (2) and (3) are not satisfied, i.e., time interval between the first access to the depended content and the present time is smaller than Δt₂, and/or successive accesses are too close.

According to an alternative rule for determining whether the behavior of the user device is acceptable, if the segments of the depended content are not accessed in an order as appeared in the media presentation timeline, or if a time interval between two successive accesses to the depended content is smaller than a predetermined time period, or if a sum of duration of the segments identified by the set {nᵢ} is smaller than a predetermined time period, i.e., minimum time a client is expected to watch the advertisement, which is preset by the service operator, and/or the like, the behavior of the user device is determined to be unacceptable. The present disclosure does not set limitations to the judgment rule of the behavior of the user device.

Alternatively, the user device may be required to submit other evidence in addition to the at least one access receipt mentioned above. For instance, additional evidence for determining whether the depended content has been processed may be required, e.g., video finger print, watermark embedded in the depended content, motion vector, specific pixel in a picture content, etc. It should be appreciated that numerous other conditions can be used to determine if the behavior of the user device is acceptable. Such conditions, known in the art or made known to one of skill in the art by way of the context provided herein, are incorporated into the present disclosure.

In an alternative embodiment, before the controller determines the access status information of the user device, the controller may detect if any one of the at least one access receipt is modified by the user device, or if the at least one access receipt belongs to the user device. If any of the at least one access receipt is detected to be modified by the user device belonging to the user device, the user device may be blocked to access any content for a period of time as a penalty. However, other operation for controlling behavior of the user device may also be performed by the controller, and no limitation is set herein.

The above description is made based on an assumption that the depended content is advertisement content. In a scenario of mid-roll advertisement, e.g., a scenario shown in FIG. 4, a user device may request a segment in the content A and a segment in the content B in parallel, e.g., after sending a request for a segment in the content A, the client sends a next request for a segment in the content B. In this case, even if the behavior of the user device on content B meets all of the above conditions, the user device may skip the content B without consuming it. In order to control such behavior of the user device, the depended content may include both the content A and content B, and the user device may be required to send the last several access receipts it stores or report all of the access receipt(s) it stores. In this case, the controller may take the period number contained in an access receipt into consideration in reconstructing behavior of the user device on the depended content, but no limitation is set herein.

The judgment result of the behavior of the user device may influence subsequent behavior of the user device. For instance, if the controller is an authorization server, and the authorization server determines that the behavior of the user device is unacceptable, it may reject the authorization request of the user device. As a result, the user device cannot access the dependent content. In this case, the authorization server may send a response for indicating that the authorization request is rejected to the user device, or inform the content server of the fact that the authorization request of the user device is rejected, such that the user device cannot access any segment of the dependent content. As an alternative, if the authorization server determines that the behavior of the user device is acceptable, it may accept the authorization request of the user device. Accordingly, the authorization server may send an access token to the user device for accessing the dependent content, or inform the content server of the authorization result. However, no limitation is set herein.

In a preferred embodiment, the communication method 300 further includes the following steps: receiving an access token for accessing the dependent content from the authorization server in response to the authorization request, and sending a second access request for a segment of the dependent content to the content server, wherein the second access request carries the access token.

Accordingly, the content server may determine whether to accept the second access request. For instance, the content server may determine whether to accept the second access request by determining whether the second access request carries an access token. Alternatively, the content server may process the access request in accordance with an authorization indication from the controller, wherein the controller may send the authorization indication to the content server on its own initiative or in response to a request from the content server. No limitation is set herein.

In the present disclosure, an access dependency relationship between two parts of a media presentation is described in an MPD file. The dependent content and depended content may be in a same period or in different periods. Accordingly, a descriptor for describing the dependency relationship may be added in the MPD file. An exemplary format of the descriptor is as follows.

<!-- Descriptor --> <xs:complexType name=″AuthorizedAccessType″>
<xs:complexContent>
<xs:extension name=″DescriptorType″>
<xs:choice>
<xs:element name=″DependedContent” type=″ContentIdType″
use=″optional″/>
<xs:element name=″DependentContent” type=″ContentIdType″
use=″optional″/>
</xs:choice>
<xs:attribute name=″authServerURL″ type=″xs:anyURI″ use=″required″/>
<xs:attribute name=″schemeId″ type=″xs:anyURI″ use=″required″/>
</xs:extension>
</xs:complextContent>
</xs:complexType>
<xs:complexType name=″ContentIdType″>
<xs:choice>
<xs:element name=″Range” >
<xs:complexType>
<xs:attribute name=″startNum″ type=″xs:unsignedInt″ use=″required″/>
<xs:attribute name=″endNum″ type=″xs:unsignedInt″ use=″required″/>
</xs:complexType>
</xs:element>
<xs:element name=″SegNumList” >
<xs:simpleType>
<xs:list itemType=″xs: unsignedInt ″/>
</xs:simpleType>
</xs:element>
<xs:choice/>
<xs:attribute name=″periodId” type=″ xs:unsignedInt″/>
<xs:attribute name=″AdaptationSetId” type=″ xs:unsignedInt″/>
<xs:attribute name=″representationId” type=″StringNoWhitespaceType″/>
<xs:attribute name=″segNum” type=″ xs:unsignedInt″/>
</xs:complexType>

where “@schemeId” identifies a scheme used for authorization, which is associated with some parameters mentioned above, e.g., structure of an access receipt, encryption manner applied to an access receipt, protocol used for authorization, etc., “@authServerURL” indicates a URL to the server where an authorization is performed, “DependentContent” indicates a part of content in a media presentation, access to which is a precondition for access to other parts of content in the media presentation, and “DependedContent” indicates a part of content in a media presentation, access to which is conditional and depends on access to the content specified by “Dependent Content”. It should be noted that the format of the descriptor is just exemplary, and the present disclosure does not set limitations on the format of the descriptor.

It can be seen from the above description that, according to the communication method provided by the present disclosure, the content server sends an access receipt to the user device upon receiving an access request for a segment of the depended content from the user device, and the access receipt contains information describing the present access to the segment of the depended content. In this way, the user device may send at least one access receipt to a controller, behavior of the user device on the depended content may be reconstructed by the controller according to the at least one access receipt, and subsequent behavior of the user device may be controlled by the controller according to the reconstructed behavior of the user device, for instance, the controller may determine whether the behavior of the user device on the depended content is desirable, and further to determine whether an authorization request of the user device for accessing the dependent content is accepted, thus enhancing control capability of the network on behavior of the user device while reserving enough flexibility of the user device. Further, an operator may determine a rule for grant of an authorization according to its own needs, and the content server may carry corresponding information in the access receipt according to the predetermined rule, thus providing more options to an operator, and improving experience of the operator.

Furthermore, in the present disclosure, a user device stores an access receipt recording an access to the depended content of a media presentation by the user device, and provides such information to the network side. In this way, a network equipment, such as the content server and/or the controller, does not need to track access status of the user device and manage behavior of the user client, thus various kinds of user devices may be supported by the network equipment, and the technical solution of the present disclosure is compatible with the design principle of DASH and is applicable to various practical scenarios.

FIG. 5 is a flowchart of another communication method 400 provided by the present disclosure. The communication method may be executed by a content server. Referring to FIG. 5, the communication method 400 includes the following steps.

Step S410: Receiving a first access request for a segment of depended content from a user device.

Step S420: Generating an access receipt according to the first access request, wherein the access receipt contains information describing present access to the segment of the depended content by the user device.

Step S430: Sending the access receipt to the user device.

According to the communication method provided by the present disclosure, the content server sends an access receipt to the user device upon receiving an access request for a segment of the depended content from the user device, and the access receipt contains information describing the present access to the segment of the depended content. In this way, the user device may send at least one access receipt to a controller, behavior of the user device on the depended content may be reconstructed by the controller according to the at least one access receipt, and subsequent behavior of the user device may be controlled by the controller according to the reconstructed behavior of the user device, for instance, the controller may determine whether the behavior of the user device on the depended content is desirable, and further to determine whether an authorization request of the user device for accessing the dependent content is accepted, thus enhancing control capability of the network on behavior of the user device while reserving enough flexibility of the user device.

In a preferred embodiment, the information contained in the access receipt includes information on at least one of access time, a segment number, segment URL, source address of the access receipt, and destination address of the access receipt.

In another preferred embodiment, the sent access receipt is in a form that any modification to it can be detected by a network side. For instance, the access receipt is structured, formatted, signed, encrypted, and/or the like. The network side may include a plurality of various network equipment, such as the content server, the controller and so forth, when a network equipment receives an access receipt from the user device, it is capable of detecting any modification made to the access receipt.

In another preferred embodiment, the communication method 400 further includes the following steps receiving a second access request for a segment of dependent content from the user device, and determining whether to send the requested segment of the dependent content to the user device.

The content server may determine whether to send the requested segment of the dependent content to the user device by various means. For instance, the content server may determine whether to send the requested segment of the dependent content to the user device by determining whether the second access request carries an access token, or in accordance with an authorization indication sent from the authorization server. The content server may send a request for an authorization result to the authorization server and receive the authorization indication in response to the request. As an alternative, the content server may receive the authorization indication initiatively sent by the authorization server. No limitation is set herein.

In an exemplary embodiment, determining whether to send the requested segment of the dependent content to the user device may include determining whether the second access request carries an access token.

Furthermore, determining whether to send the requested segment of the dependent content to the user device may include the following steps: determining to send the requested segment of the dependent content to the user device if the second access request carries an access token, and determining not to send the requested segment of the dependent content to the user device if the second access request does not carry an access token.

In an alternative embodiment, before determining whether to send the requested segment of the dependent content to the user device, the communication method 400 further includes a step of receiving an authorization indication for indicating whether the user device is authorized to access the dependent content.

Accordingly, determining whether to send the requested segment of the dependent content to the user device may include the following steps determining to send the requested segment of the dependent content to the user device if the authorization indication indicates that the user device is authorized to access the dependent content, and determining not to send the requested segment of the dependent content to the user device if the authorization indication indicates that the user device is unauthorized to access the dependent content.

It can be seen from the above description that, according to the communication method provided by the present disclosure, the content server sends an access receipt to the user device upon receiving an access request for a segment of the depended content from the user device, and the access receipt contains information describing the present access to the segment of the depended content. In this way, the user device may send at least one access receipt to a controller, behavior of the user device on the depended content may be reconstructed by the controller according to the at least one access receipt, and subsequent behavior of the user device may be controlled by the controller according to the reconstructed behavior of the user device, for instance, the controller may determine whether the behavior of the user device on the depended content is desirable, and further to determine whether an authorization request of the user device for accessing the dependent content is accepted, thus enhancing control capability of the network on behavior of the user device while reserving enough flexibility of the user device. Further, an operator may determine a rule for grant of an authorization according to its own needs, and the content server may carry corresponding information in the access receipt according to the predetermined rule, thus providing more options to an operator, and improving the experience of the operator.

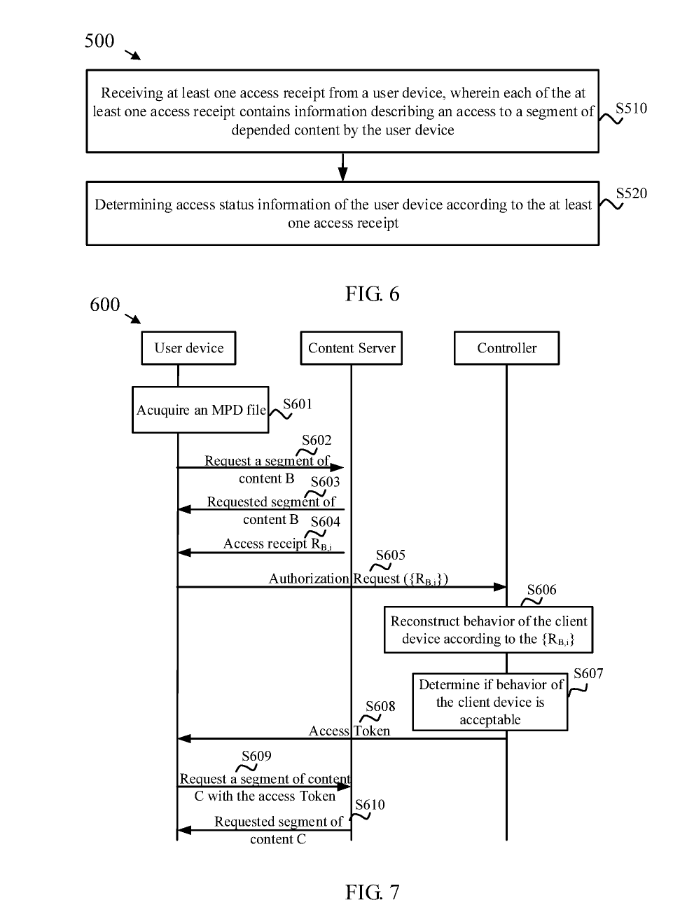

FIG. 6 is a flowchart of another communication method 500 provided by the present disclosure. The communication method 500 may be executed by a controller. Referring to FIG. 6, the communication method 500 includes the following steps.

Step S510: Receiving at least one access receipt from a user device, wherein each of the at least one access receipt contains information describing an access to a segment of depended content by the user device.

Step S520: Determining access status information of the user device according to the at least one access receipt.

According to the communication method provided by the present disclosure, the content server sends an access receipt to the user device upon receiving an access request for a segment of the depended content from the user device, and the access receipt contains information describing the present access to the segment of the depended content. In this way, the user device may send at least one access receipt to a controller, behavior of the user device on the depended content may be reconstructed by the controller according to the at least one access receipt, and subsequent behavior of the user device may be controlled by the controller according to the reconstructed behavior of the user device, for instance, the controller may determine whether the behavior of the user device on the depended content is desirable, and further to determine whether an authorization request of the user device for accessing the dependent content is accepted, thus enhancing control capability of the network on behavior of the user device while reserving enough flexibility of the user device.

If the user device does not receive any access receipt, i.e., number of the access receipt the user device has is equal to zero, the communication method 500 may include receiving an access receipt indication for indicating that the user device has no access receipt from a user device, according to which the controller may determine that the user device does not have access the depended content.

The access status information is used for identifying access status of the user device regarding the depended content. According to the access status information, the controller may do some statistics over multiple user devices or report the information to an operator, or reconstruct behavior of the user device on the depended content, etc. In some aspects of the present disclosure, the communication method 500 may further include controlling behavior of the user device according to the access status information of the user device, such as controlling behavior of the user device on dependent content and the like.

In a preferred embodiment, the information containing each of the at least one access receipt may include information on at least one of access time, a segment number, segment URL, source address of the access receipt, and destination address of the access receipt.

In an alternative embodiment, the access status information of the user device includes information on at least one of a number of times the user device accesses the depended content, which segment of the depended content is accessed by the user device, and time when the user device accesses a segment of the depended content. In some aspects of the present disclosure, the access status information may include other information, and no limitation is set herein.

In a preferred embodiment, the controller may be an authorization server. Accordingly, step S510 may include receiving an authorization request carrying at least one access receipt from the user device, wherein the authorization request is used for requesting authorization for access to dependent content. In this case, controlling behavior of the user device according to the access status information of the user device may include determining whether the authorization request is accepted according to the access status information of the user device.

The user device is able to access the dependent content if the authorization request is accepted. Otherwise, the user device cannot access the dependent content.

In a preferred embodiment, determining whether the authorization request is accepted according to the access status information of the user device includes determining that the authorization request is rejected if the access status information of the user device indicates that at least one of the following conditions is met: a number of segments of the depended content the user device has accessed is less than a threshold number, time interval between two successive accesses to the depended content is shorter than a first threshold time period, time interval between the first access to the depended content and the last access to the depended content is longer than a third threshold time period, time period from the first access to the depended content to sending the authorization request is shorter than a fourth threshold time period, and segments of the depended content are not accessed in an order as appeared in the media presentation timeline.

In the present disclosure, other conditions may also be employed to determine whether the authorization request is accepted, and no limitation is set herein.

In an exemplary embodiment, if it is determined that the authorization request is accepted, the communication method 500 further includes sending an access token for accessing to the dependent content to the user device, or sending an authorization indication for indicating that the user device is authorized to access the dependent content to a content server.

In an alternative embodiment, if it is determined that the authorization request is rejected, the controller may do nothing, and if the user device does not receive any response to the authorization request, the user device knows that the authorization request is rejected, or if the content server does not receive any authorization indication from the controller, and it receives an access request without an access token being carried, it rejects the access request. As an alternative, the communication method 500 further includes a step of sending an authorization rejection response to the user device, or sending an authorization indication for indicating that the user device is unauthorized to access the dependent content to a content server.

In an alternative embodiment, before the controller determines the access status information of the user device, the controller may detect if any one of the at least one access receipt is modified by the user device, or if the at least one access receipt belongs to the user device. If any of the at least one access receipt is detected to be modified by the user device belonging to the user device, the user device may be blocked to access any content for a period of time as a penalty. However, other operations for controlling behavior of the user device may also be performed by the controller, and no limitation is set herein.

It can be seen from the above description that, according to the communication method provided by the present disclosure, the content server sends an access receipt to the user device upon receiving an access request for a segment of the depended content from the user device, and the access receipt contains information describing the present access to the segment of the depended content. In this way, the user device may send at least one access receipt to a controller, behavior of the user device on the depended content may be reconstructed by the controller according to the at least one access receipt, and subsequent behavior of the user device may be controlled by the controller according to the reconstructed behavior of the user device, for instance, the controller may determine whether the behavior of the user device on the depended content is desirable, and further to determine whether an authorization request of the user device for accessing the dependent content is accepted, thus enhancing control capability of the network on behavior of the user device while reserving enough flexibility of the user device. Further, an operator may determine a rule for grant of an authorization according to its own needs, and the content server may carry corresponding information in the access receipt according to the predetermined rule, thus providing more options to an operator, and improving experience of the operator.

FIG. 7 is a flowchart of another communication method 600 provided by the present disclosure. In the communication method 600, it is assumed that the media presentation to be consumed is the one as shown in FIG. 4, whereby depended content of the media presentation includes the content B, and the dependent content is content C. As shown in FIG. 7, the communication method 600 includes the following steps.

Step S601: A user device acquires an MPD file of the media presentation, wherein the MPD file contains information describing access dependency of two pieces of content in the media presentation.

A user device may acquire the MPD file by various means. The user device parses the MPD file and obtains information contained in the MPD file. Then the user device determines which segment of the media content to access according to the obtained information.

Step S602: The user device sends to a content server a first access request for a segment of content B.

Step S603: The content server sends the requested content of the content B to the user device.

Step S604: The content server generates an access receipt (R_{B,i}) containing information on the present access of the user device to the requested segment of the content B, and sends the access receipt to the user device.

In the present disclosure, the access receipt R_{B,i} may represent an access receipt R_{B,i} for an access to the i^{th} segment of the content B, or represent an access receipt for the i^{th} access to the content B. In some aspects of the present disclosure, the access receipt may contain information on at least one of access time, a segment number, segment URL, source address of the access receipt, destination address of the access receipt, a period identifier, and an identifier of the user device. However, no limitation is set herein.

The content server may send the requested segment and the access receipt together by carrying them in a response message, or send the requested segment and the access receipt separately in any order, e.g., send the requested segment firstly and then the access receipt, or send the access receipt firstly and then the requested segment.

Step S605: The user device sends an authorization request to an authorization server, wherein the authorization request is used for requesting authorization for accessing to a segment of the content C and carries an access receipt set {R_{B,i}}.

The number of elements included in the access receipt set {R_{B,i}} may be equal to or greater than zero. If the access receipt set {R_{B,i}} is an empty set, the user device may set at least one bit corresponding to the access receipt set {R_{B,i}} to be zero, or send an indicator to the controller. No limitation is set herein.

Step S606: The authorization server determines access status information of the user device according to the access receipt set {R_{B,i}}, and reconstructs behavior of the user device on the content B.

Step S607: The authorization server judges if the reconstructed behavior of the user device is acceptable.

The implementations of step S606 and step S607 may be referred to by the foregoing description, and will not be described reluctantly herein. If the authorization determines that the behavior of the user device is acceptable, the authorization may send an authorization indication for indicating that the client server is authorized to access the content C to the content server, or execute step S608.

Step S608: The authorization server sends an access token to the user device.

Step S609: The user device sends a second access request for a segment of the content C to the content server, wherein the second access request carries the access token.

Step S610: The content server sends the requested segment of the content C to the user device.

The content server determines that the user device is authorized to access the content C according to the access token, and then sends the requested segment to the user device.

It can be seen from the above description that, according to the communication method provided by the present disclosure, the content server sends an access receipt to the user device upon receiving an access request for a segment of the depended content from the user device, and the access receipt contains information describing the present access to the segment of the depended content. Before accessing to a segment of the dependent content, the user device sends an authorization request containing at least one access receipt it receives to the authorization server, and behavior of the user device on the depended content may be reconstructed by the authorization server according to the at least one access receipt, and whether the authorization request of the user device for accessing the dependent content is accepted is further determined according to the reconstructed behavior of the user device, thus enhancing control capability of the network on behavior of the user device while reserving enough flexibility of the user device. Further, an operator may determine a rule for grant of an authorization according to its own needs, and the content server may carry corresponding information in the access receipt according to the predetermined rule, thus providing more options to an operator, and improving experience of the operator.

The foregoing describes various embodiments of the communication method provided by the present disclosure. For purpose of simplicity of explanation, the communication methods are described as a series of acts, however, it is to be understood and appreciated that the communication methods are not limited by the order of acts. For example, in accordance with one or more aspects of the present disclosure, some acts may occur in different orders and/or concurrently with other acts from that are shown and described herein. Further, a user device, a content server and a controller corresponding to various aspects of the communication method are described in detail.

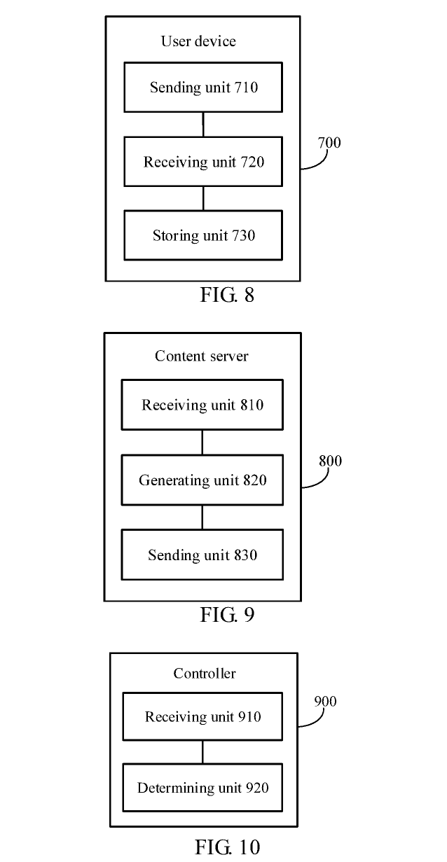

FIG. 8 is an exemplary block diagram of a user device 700 provided by the present disclosure. Referring to FIG. 8, the user device 700 includes a sending unit 710, a receiving unit 720 and a storing unit 730, wherein the sending unit 710 is configured to send a first access request for a segment of depended content to a content server, wherein the depended content includes at least one segment. The receiving unit 720 is configured to receive an access receipt from the content server, wherein the access receipt contains information describing present access to the segment of the depended content requested by the first access request sent by the sending unit 710, and the storing unit 730 is configured to store the access receipt received by the receiving unit 720.

According to the user device provided by the present disclosure, the content server sends an access receipt to the user device upon receiving an access request for a segment of the depended content from the user device, and the access receipt contains information describing the present access to the segment of the depended content. In this way, the user device may send at least one access receipt to a controller, behavior of the user device on the depended content may be reconstructed by the controller according to the at least one access receipt, and subsequent behavior of the user device may be controlled by the controller according to the reconstructed behavior of the user device, for instance, the controller may determine whether the behavior of the user device on the depended content is desirable, and further to determine whether an authorization request of the user device for accessing the dependent content is accepted, thus enhancing control capability of the network on behavior of the user device while reserving enough flexibility of the user device.

Alternatively, the information contained in the access receipt may include information on at least one of access time, a segment number, segment URL, source address of the access receipt, and destination address of the access receipt.

In a preferred embodiment, the access receipt is encrypted or signed by the content server.

In an alternative embodiment, the sending unit 710 is further configured to send at least one access receipt stored by the storing unit 730 to a controller, wherein each of the at least one access receipt contains information describing an access to a segment of the depended content, such that access status information of the user device is determined by the controller according to the at least one access receipt.

Alternatively, the at least one access receipt sent by the sending unit 710 includes at least one of first M₁ access receipt(s) of access receipt(s) stored by the user device and last M₂ access receipt(s) of the access receipt(s) stored by the storing unit 730, wherein M₁ and M₂ are integers equal to or greater than one.

In an exemplary embodiment, the access status information of the user device includes information on at least one of a number of times the user device accesses the depended content, which segment of the depended content is accessed by the user device and time when the user device accesses a segment of the depended content.

In a preferred embodiment, the controller is an authorization server, and the sending unit 710 is further configured to send an authorization request carrying the at least one access receipt to the authorization server, wherein the authorization request is used for requesting authorization for access to dependent content. Accordingly, the access status information is used to determine whether the authorization request sent by the sending unit 710 is accepted by the authorization server.

In some aspects of the present disclosure, the receiving unit 720 is further configured to receive an access token for accessing the dependent content from the authorization server in response to the authorization request sent by the sending unit 710, and the sending unit 710 is further configured to send a second access request for a segment of the dependent content to the content server, wherein the second access request carries the access token received by the receiving unit 720. The user device 700 may have other function and/or unit in accordance with various aspects of the communication method provided by the present disclosure, and no limitation is set herein.

It can be seen from the above description that, according to the user device provided by the present disclosure, the content server sends an access receipt to the user device upon receiving an access request for a segment of the depended content from the user device, and the access receipt contains information describing the present access to the segment of the depended content. In this way, the user device may send at least one access receipt to a controller, behavior of the user device on the depended content may be reconstructed by the controller according to the at least one access receipt, and subsequent behavior of the user device may be controlled by the controller according to the reconstructed behavior of the user device. For instance, the controller may determine whether the behavior of the user device on the depended content is desirable, and further to determine whether an authorization request of the user device for accessing the dependent content is accepted, thus enhancing control capability of the network on behavior of the user device while reserving enough flexibility of the user device. Further, an operator may determine a rule for grant of an authorization according to its own needs, and the content server may carry corresponding information in the access receipt according to the predetermined rule, thus providing more options to an operator, and improving the experience of the operator.

FIG. 9 is an exemplary block diagram of a content server 800 provided by the present disclosure. Referring to FIG. 9, the content server 800 includes a receiving unit 810, a generating unit 820 and a sending unit 830, wherein the receiving unit 810 is configured to receive a first access request for a segment of depended content from a user device, the generating unit 820 is configured to generate an access receipt according to the first access request received by the receiving unit 810, wherein the access receipt contains information describing present access to the segment of the depended content by the user device, and the sending unit 830 is configured to send the access receipt generated by the generating unit 820 to the user device.

According to the content server provided by the present disclosure, the content server sends an access receipt to the user device upon receiving an access request for a segment of the depended content from the user device, and the access receipt contains information describing the present access to the segment of the depended content. In this way, the user device may send at least one access receipt to a controller, behavior of the user device on the depended content may be reconstructed by the controller according to the at least one access receipt, and subsequent behavior of the user device may be controlled by the controller according to the reconstructed behavior of the user device, for instance, the controller may determine whether the behavior of the user device on the depended content is desirable, and further to determine whether an authorization request of the user device for accessing the dependent content is accepted, thus enhancing control capability of the network on behavior of the user device while reserving enough flexibility of the user device.

Alternatively, the information contained in the access receipt includes information on at least one of access time, a segment number, segment URL, source address of the access receipt, and destination address of the access receipt.

In a preferred embodiment, the access receipt sent by the sending unit 830 is in a form that any modification to it can be detected by a network side.

Alternatively, the access receipt is encrypted or signed by the content server.

Alternatively, the receiving unit 810 is further configured to receive a second access request for a segment of dependent content from the user device, and wherein the content server 800 further includes a determining unit configured to determine whether to send the segment of the dependent content requested by the second access request received by the receiving unit 810 to the user device.

In an alternative embodiment, the determining unit is further configured to determine to send the requested segment of the dependent content to the user device if the second access request received by the receiving unit 810 carries an access token, and determine not to send the requested segment of the dependent content to the user device if the second access request received by the receiving unit 810 does not carry an access token.

Alternatively, the receiving unit 810 is further configured to receive, before the determining unit 840 determines whether to send the requested segment of the dependent content to the user device, an authorization indication for indicating whether the user device is authorized to access the dependent content, and the determining unit is further configured to determine to send the requested segment of the dependent content to the user device if the authorization indication received by the receiving unit 810 indicates that the user device is authorized to access the dependent content, and determine not to send the requested segment of the dependent content to the user device if the authorization indication received by the receiving unit 810 indicates that the user device is unauthorized to access the dependent content.

The content server 800 may have other function and/or unit in accordance with various aspects of the communication method provided by the present disclosure, and no limitation is set herein.

It can be seen from the above description that, according to the content server provided by the present disclosure, the content server sends an access receipt to the user device upon receiving an access request for a segment of the depended content from the user device, and the access receipt contains information describing the present access to the segment of the depended content. In this way, the user device may send at least one access receipt to a controller, behavior of the user device on the depended content may be reconstructed by the controller according to the at least one access receipt, and subsequent behavior of the user device may be controlled by the controller according to the reconstructed behavior of the user device, for instance, the controller may determine whether the behavior of the user device on the depended content is desirable, and further to determine whether an authorization request of the user device for accessing the dependent content is accepted, thus enhancing control capability of the network on behavior of the user device while reserving enough flexibility of the user device. Further, an operator may determine a rule for grant of an authorization according to its own needs, and the content server may carry corresponding information in the access receipt according to the predetermined rule, thus providing more options to an operator, and improving experience of the operator.

FIG. 10 is an exemplary block diagram of a controller 900 provided by the present disclosure. Referring to FIG. 10, the controller 900 includes a receiving unit 910 and a determining unit 920, wherein the receiving unit 910 is configured to receive at least one access receipt from a user device, wherein each of the at least one access receipt contains information describing an access to a segment of depended content by the user device, and the determining unit 920 is configured to determine access status information of the user device according to the at least one access receipt received by the receiving unit 910.

According to the controller provided by the present disclosure, the content server sends an access receipt to the user device upon receiving an access request for a segment of the depended content from the user device, and the access receipt contains information describing the present access to the segment of the depended content. In this way, the user device may send at least one access receipt to a controller, behavior of the user device on the depended content may be reconstructed by the controller according to the at least one access receipt, and subsequent behavior of the user device may be controlled by the controller according to the reconstructed behavior of the user device, for instance, the controller may determine whether the behavior of the user device on the depended content is desirable, and further to determine whether an authorization request of the user device for accessing the dependent content is accepted, thus enhancing control capability of the network on behavior of the user device while reserving enough flexibility of the user device.

Alternatively, the information contained in an access receipt of the at least one access receipt includes information on at least one of access time, a segment number, segment URL, source address of the access receipt, and destination address of the access receipt.

Alternatively, the controller 900 may further include a controlling unit configured to control behavior of the user device according to the access status information determined by the determining unit 920.

Furthermore, the controller 900 may reconstruct behavior of the user device based on the access status information determined by the determining unit 920, and control subsequent behavior of the user device, such as behavior of the user device on dependent content and the like.

Alternatively, the access status information of the user device determined by the determining unit 920 includes information on at least one of a number of times the user device accesses the depended content, which segment of the depended content is accessed by the user device, and time when the user device accesses a segment of the depended content.

In a preferred embodiment, the controller 900 is an authorization server. Accordingly, the receiving unit 910 is further configured to receive an authorization request carrying at least one access receipt from the user device, wherein the authorization request is used for requesting authorization for access to dependent content, and the determining unit 920 is further configured to determine whether the authorization request received by the receiving unit 910 is accepted according to the access status information of the user device.

In an alternative embodiment, the determining unit 920 is further configured to determine that the authorization request is rejected if the access status information of the user device indicates that at least one of the following conditions is met: a number of segments of the depended content the user device has accessed is less than a threshold number, time interval between two successive accesses to the depended content is shorter than a first threshold time period, time interval between the first access to the depended content and the last access to the depended content is longer than a third threshold time period, time period from the first access to the depended content to sending the authorization request is shorter than a fourth threshold time period, and segments of the depended content are not accessed in an order as appeared in the media presentation timeline.

Alternatively, if the determining unit 920 determines that the authorization request is accepted, the controller further includes a sending unit configured to send an access token for accessing to the dependent content to the user device, or configured to send an authorization indication for indicating that the user device is authorized to access the dependent content to a content server.

The controller 900 may have other function and/or unit in accordance with various aspects of the communication method provided by the present disclosure, and no limitation is set herein.

It can be seen from the above description that, according to the controller provided by the present disclosure, the content server sends an access receipt to the user device upon receiving an access request for a segment of the depended content from the user device, and the access receipt contains information describing the present access to the segment of the depended content. In this way, the user device may send at least one access receipt to a controller, behavior of the user device on the depended content may be reconstructed by the controller according to the at least one access receipt, and subsequent behavior of the user device may be controlled by the controller according to the reconstructed behavior of the user device, for instance, the controller may determine whether the behavior of the user device on the depended content is desirable, and further to determine whether an authorization request of the user device for accessing the dependent content is accepted, thus enhancing control capability of the network on behavior of the user device while reserving enough flexibility of the user device. Further, an operator may determine a rule for grant of an authorization according to its own needs, and the content server may carry corresponding information in the access receipt according to the predetermined rule, thus providing more options to an operator, and improving the experience of the operator.

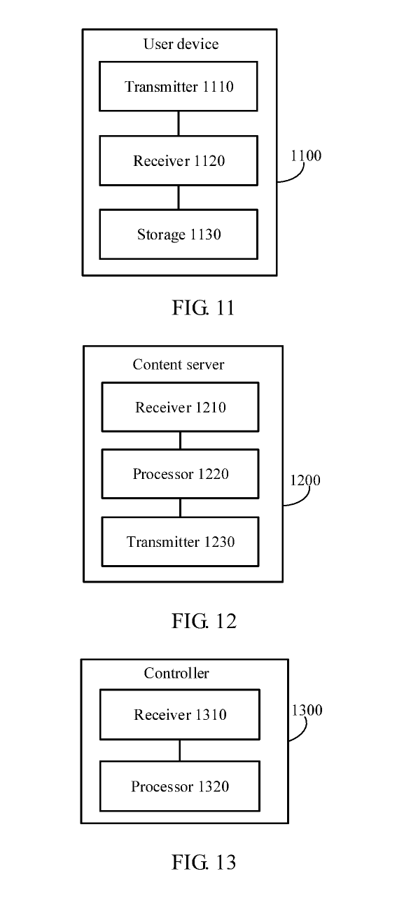

FIG. 11 is an exemplary block diagram of another user device 1100 provided by the present disclosure. Referring to FIG. 11, the user device 1100 includes a transmitter 1110, a receiver 1120 and a storage 1130, wherein the transmitter 1110 is configured to send a first access request for a segment of depended content to a content server, wherein the depended content includes at least one segment, the receiver 1120 is configured to receive an access receipt from the content server, wherein the access receipt contains information describing present access to the segment of the depended content requested by the first access request sent by the transmitter 1110, and the storage 1130 is configured to store the access receipt received by the receiver 1120.

According to the user device provided by the present disclosure, the content server sends an access receipt to the user device upon receiving an access request for a segment of the depended content from the user device, and the access receipt contains information describing the present access to the segment of the depended content. In this way, the user device may send at least one access receipt to a controller, behavior of the user device on the depended content may be reconstructed by the controller according to the at least one access receipt, and subsequent behavior of the user device may be controlled by the controller according to the reconstructed behavior of the user device. For instance, the controller may determine whether the behavior of the user device on the depended content is desirable, and further to determine whether an authorization request of the user device for accessing the dependent content is accepted, thus enhancing control capability of the network on behavior of the user device while reserving enough flexibility of the user device.

Alternatively, the information contained in the access receipt may include information on at least one of access time, a segment number, segment URL, source address of the access receipt, and destination address of the access receipt.

In a preferred embodiment, the access receipt is encrypted or signed by the content server.

In an alternative embodiment, the transmitter 1110 is further configured to send at least one access receipt stored by the storage 1130 to a controller, wherein each of the at least one access receipt contains information describing an access to a segment of the depended content, such that access status information of the user device is determined by the controller according to the at least one access receipt.

Alternatively, the at least one access receipt sent by the transmitter 1110 includes at least one of first M₁ access receipt(s) of access receipt(s) stored by the user device and last M₂ access receipt(s) of the access receipt(s) stored by the storage 1130, wherein M₁ and M₂ are integers equal to or greater than one.

In an exemplary embodiment, the access status information of the user device includes information on at least one of a number of times the user device accesses the depended content, which segment of the depended content is accessed by the user device and time when the user device accesses a segment of the depended content.

In a preferred embodiment, the controller is an authorization server, and the transmitter 1110 is further configured to send an authorization request carrying the at least one access receipt to the authorization server, wherein the authorization request is used for requesting authorization for access to dependent content. Accordingly, the access status information is used to determine whether the authorization request sent by the transmitter 1110 is accepted by the authorization server.

In some aspects of the present disclosure, the receiver 1120 is further configured to receive an access token for accessing the dependent content from the authorization server in response to the authorization request sent by the transmitter 1110, and the transmitter 1110 is further configured to send a second access request for a segment of the dependent content to the content server, wherein the second access request carries the access token received by the receiver 1120. The user device 1100 may have other function and/or unit in accordance with various aspects of the communication method provided by the present disclosure, and no limitation is set herein.

It can be seen from the above description that, according to the user device provided by the present disclosure, the content server sends an access receipt to the user device upon receiving an access request for a segment of the depended content from the user device, and the access receipt contains information describing the present access to the segment of the depended content. In this way, the user device may send at least one access receipt to a controller, behavior of the user device on the depended content may be reconstructed by the controller according to the at least one access receipt, and subsequent behavior of the user device may be controlled by the controller according to the reconstructed behavior of the user device, for instance, the controller may determine whether the behavior of the user device on the depended content is desirable, and further to determine whether an authorization request of the user device for accessing the dependent content is accepted, thus enhancing control capability of the network on behavior of the user device while reserving enough flexibility of the user device. Further, an operator may determine a rule for grant of an authorization according to its own needs, and the content server may carry corresponding information in the access receipt according to the predetermined rule, thus providing more options to an operator, and improving the experience of the operator.

FIG. 12 is an exemplary block diagram of another content server 1200 provided by the present disclosure. Referring to FIG. 12, the content server 1200 includes a receiver 1210, a processor 1220 and a transmitter 1230, wherein the receiver 1210 is configured to receive a first access request for a segment of depended content from a user device, the processor 1220 is configured to generate an access receipt according to the first access request received by the receiver 1210, wherein the access receipt contains information describing present access to the segment of the depended content by the user device, and the transmitter 1230 is configured to send the access receipt generated by the processor 1220 to the user device.

According to the content server provided by the present disclosure, the content server sends an access receipt to the user device upon receiving an access request for a segment of the depended content from the user device, and the access receipt contains information describing the present access to the segment of the depended content. In this way, the user device may send at least one access receipt to a controller, behavior of the user device on the depended content may be reconstructed by the controller according to the at least one access receipt, and subsequent behavior of the user device may be controlled by the controller according to the reconstructed behavior of the user device. For instance, the controller may determine whether the behavior of the user device on the depended content is desirable, and further to determine whether an authorization request of the user device for accessing the dependent content is accepted, thus enhancing control capability of the network on behavior of the user device while reserving enough flexibility of the user device.

Alternatively, the information contained in the access receipt includes information on at least one of access time, a segment number, segment URL, source address of the access receipt, and destination address of the access receipt.

In a preferred embodiment, the access receipt sent by the transmitter 1230 is in a form that any modification to it can be detected by a network side.

Alternatively, the access receipt is encrypted or signed by the content server.

Alternatively, the receiver 1210 is further configured to receive a second access request for a segment of dependent content from the user device, and the processor 1220 is further configured to determine whether to send the segment of the dependent content requested by the second access request received by the receiver 1210 to the user device.

In an alternative embodiment, the processor 1220 is further configured to determine to send the requested segment of the dependent content to the user device if the second access request received by the receiver 1210 carries an access token, and determine not to send the requested segment of the dependent content to the user device if the second access request received by the receiver 1210 does not carry an access token.

Alternatively, the receiver 1210 is further configured to receive, before the processor 1220 determines whether to send the requested segment of the dependent content to the user device, an authorization indication for indicating whether the user device is authorized to access the dependent content, and the processor 1220 is further configured to determine to send the requested segment of the dependent content to the user device if the authorization indication received by the receiver 1210 indicates that the user device is authorized to access the dependent content, and determine not to send the requested segment of the dependent content to the user device if the authorization indication received by the receiver 1210 indicates that the user device is unauthorized to access the dependent content.

The content server 1200 may have other function and/or unit in accordance with various aspects of the communication method provided by the present disclosure, and no limitation is set herein.

It can be seen from the above description that, according to the content server provided by the present disclosure, the content server sends an access receipt to the user device upon receiving an access request for a segment of the depended content from the user device, and the access receipt contains information describing the present access to the segment of the depended content. In this way, the user device may send at least one access receipt to a controller, behavior of the user device on the depended content may be reconstructed by the controller according to the at least one access receipt, and subsequent behavior of the user device may be controlled by the controller according to the reconstructed behavior of the user device. For instance, the controller may determine whether the behavior of the user device on the depended content is desirable, and further to determine whether an authorization request of the user device for accessing the dependent content is accepted, thus enhancing control capability of the network on behavior of the user device while reserving enough flexibility of the user device. Further, an operator may determine a rule for grant of an authorization according to its own needs, and the content server may carry corresponding information in the access receipt according to the predetermined rule, thus providing more options to an operator, and improving experience of the operator.

FIG. 13 is an exemplary block diagram of another controller 1300 provided by the present disclosure. Referring to FIG. 13, the controller 1300 includes a receiver 1310 and a processor 1320, wherein the receiver 1310 is configured to receive at least one access receipt from a user device, wherein each of the at least one access receipt contains information describing an access to a segment of depended content by the user device, and the processor 1320 is configured to determine access status information of the user device according to the at least one access receipt received by the receiver 1310.

According to the controller provided by the present disclosure, the content server sends an access receipt to the user device upon receiving an access request for a segment of the depended content from the user device, and the access receipt contains information describing the present access to the segment of the depended content. In this way, the user device may send at least one access receipt to a controller, behavior of the user device on the depended content may be reconstructed by the controller according to the at least one access receipt, and subsequent behavior of the user device may be controlled by the controller according to the reconstructed behavior of the user device, for instance, the controller may determine whether the behavior of the user device on the depended content is desirable, and further to determine whether an authorization request of the user device for accessing the dependent content is accepted, thus enhancing control capability of the network on behavior of the user device while reserving enough flexibility of the user device.

Alternatively, the information contained in an access receipt of the at least one access receipt includes information on at least one of access time, a segment number, segment URL, source address of the access receipt, and destination address of the access receipt.

Alternatively, the processor 1320 may be further configured to control behavior of the user device according to the access status information.

Furthermore, the processor 1320 may reconstruct behavior of the user device based on the access status information, and control subsequent behavior of the user device, such as behavior of the user device on dependent content and the like.

Alternatively, the access status information of the user device determined by the processor 1320 includes information on at least one of a number of times the user device accesses the depended content, which segment of the depended content is accessed by the user device and time when the user device accesses a segment of the depended content.

In a preferred embodiment, the controller 1300 is an authorization server. Accordingly, the receiver 1310 is further configured to receive an authorization request carrying at least one access receipt from the user device, wherein the authorization request is used for requesting authorization for access to dependent content, and the processor 1320 is further configured to determine whether the authorization request received by the receiver 1310 is accepted according to the access status information of the user device.

In an alternative embodiment, the processor 1320 is further configured to determine that the authorization request is rejected if the access status information of the user device indicates that at least one of the following conditions is met: a number of segments of the depended content the user device has accessed is less than a threshold number, time interval between two successive accesses to the depended content is shorter than a first threshold time period, time interval between the first access to the depended content and the last access to the depended content is longer than a third threshold time period, time period from the first access to the depended content to sending the authorization request is shorter than a fourth threshold time period, and segments of the depended content are not accessed in an order as appeared in the media presentation timeline.

Alternatively, if the processor 1320 determines that the authorization request is accepted, the controller further includes a transmitter configured to send an access token for accessing to the dependent content to the user device, or configured to send an authorization indication for indicating that the user device is authorized to access the dependent content to a content server.

The controller 1300 may have other function and/or unit in accordance with various aspects of the communication method provided by the present disclosure, and no limitation is set herein.

It can be seen from the above description that, according to the controller provided by the present disclosure, the content server sends an access receipt to the user device upon receiving an access request for a segment of the depended content from the user device, and the access receipt contains information describing the present access to the segment of the depended content. In this way, the user device may send at least one access receipt to a controller, behavior of the user device on the depended content may be reconstructed by the controller according to the at least one access receipt, and subsequent behavior of the user device may be controlled by the controller according to the reconstructed behavior of the user device. For instance, the controller may determine whether the behavior of the user device on the depended content is desirable, and further to determine whether an authorization request of the user device for accessing the dependent content is accepted, thus enhancing control capability of the network on behavior of the user device while reserving enough flexibility of the user device. Further, an operator may determine a rule for grant of an authorization according to its own needs, and the content server may carry corresponding information in the access receipt according to the predetermined rule, thus providing more options to an operator, and improving the experience of the operator.

It should be appreciated that the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concept in a concrete fashion. As used in the present disclosure, the term “and/or” is intended to mean an inclusive “and/or”. That is, unless specified otherwise, or clear from context, “X includes A and/or B” is intended to mean any of natural inclusive permutations, i.e., X may be A, or X may be B, or X may be A and B.

Various embodiments are described in the general context of method steps or processes, which may be implemented in one embodiment by a computer program product, embodied in a computer-readable memory, including computer-executable instructions, such as program code, executed by computers in networked environments. A computer-readable memory may include removable and non-removable storage devices including, but not limited to, read only memory (ROM), random access memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes. Various embodiments may include a computer-readable medium including computer-executable instructions which, when executed by a processor, cause an apparatus to perform the methods and processors described herein.

Embodiments of the present disclosure may be implemented in software, hardware, application logic or a combination thereof. The software, application logic and/or hardware may reside on a user device, or a controller, such as a content server or a controller. In an exemplary embodiment, the application logic, software or an instruction set is maintained on any one of various conventional computer-readable media. In the context of the present disclosure, the term “computer-readable medium” may be any media or means that can contain, store, communicate, propagate or transport the instructions for use by or in connection with an instruction execution system, apparatus or device, such as a computer.

In the end, it should be noted that the preceding embodiments are merely used to illustrate the technical solutions of the present disclosure rather than limiting the present disclosure. Though the present disclosure is illustrated in detail by referring to the preceding embodiments, it should be understood by one of skill in the art that modifications may still be made on the technical solutions disclosed in the preceding respective embodiments, or equivalent alterations may be made to a part of the technical characteristics thereof, and these modifications or alterations do not make the nature of corresponding technical solutions depart from the spirit and scope of the technical solutions of the respective embodiments of the present disclosure.

What is claimed is:

1. A communication method, comprising:
sending a first access request for a segment of depended content to a content server, wherein the depended content comprises at least one segment;
receiving an access receipt from the content server, wherein the access receipt contains information describing present access to the segment of the depended content by a user device; and
storing the access receipt.

2. The method of claim 1, wherein the information contained in the access receipt comprises information on at least one of access time, a segment number, segment uniform resource locator (URL), source address of the access receipt, and destination address of the access receipt.

3. The method of claim 1, wherein the access receipt is encrypted or signed by the content server.

4. The method of claim 1, further comprising sending at least one access receipt stored by the user device to a controller, wherein each of the at least one access receipt contains information describing an access to the segment of the depended content such that access status information of the user device is determined by the controller according to the at least one access receipt.

5. The method of claim 4, wherein the access receipt comprises at least one of first M₁ access receipt(s) of access receipt(s) stored by the user device and last M₂ access receipt(s) of the access receipt(s) stored by the user device, and wherein M₁ and M₂ are integers equal to or greater than one.

6. The method of claim 4, wherein the access status information of the user device comprises information on at least one of a number of times the user device accesses the depended content, which segment of the depended content is accessed by the user device, and a time when the user device accesses the segment of the depended content.

7. The method of claim 4, wherein the controller is an authorization server, wherein sending at least one access receipt stored by the user device to the controller comprises sending an authorization request carrying the at least one access receipt to the authorization server, wherein the authorization request is used for requesting authorization for access to a dependent content, and wherein the access status information is used to determine whether the authorization request is accepted by the authorization server.

8. The method of claim 7, further comprising:
receiving an access token for accessing the dependent content from the authorization server in response to the authorization request; and
sending a second access request for the segment of the dependent content to the content server, wherein the second access request carries the access token.

9. A user device, comprising:
a transmitter configured to send a first access request for a segment of depended content to a content server, wherein the depended content comprises at least one segment;
a receiver configured to receive an access receipt from the content server, wherein the access receipt contains information describing present access to the segment of the depended content requested by the first access request sent by the transmitter; and
a memory coupled to the transmitter and receiver and configured to store the access receipt received by the receiver.

10. The user device of claim 9, wherein the information contained in the access receipt comprises information on at least one of access time, a segment number, a segment uniform resource locator (URL), a source address of the access receipt, and a destination address of the access receipt.

11. The user device of claim 9, wherein the access receipt is encrypted or signed by the content server.

12. The user device of claim 9, wherein the transmitter is further configured to send at least one access receipt stored by the memory to a controller, and wherein each access receipt contains information describing an access to the segment of the depended content such that access status information of the user device is determined according to the at least one access receipt.

13. The user device of claim 12, wherein the at least one access receipt comprises at least one of first M₁ access receipt(s) of access receipt(s) stored by the memory and last M₂ access receipt(s) of the access receipt(s) stored by the memory, wherein M₁ and M₂ are integers equal to or greater than one.

14. The method of claim 12, wherein the access status information of the user device comprises information on at least one of a number of times the user device accesses the depended content, which segment of the depended content is accessed by the user device, and a time when the user device accesses the segment of the depended content.

15. The user device of claim 12, wherein the controller is an authorization server, wherein the transmitter is further configured to send an authorization request carrying the at least one access receipt to the authorization server, wherein the authorization request being used for requesting authorization for access to the dependent content, and wherein the access status information is used to determine whether the authorization request sent by the transmitter is accepted by the authorization server.

16. The user device of claim 15, wherein the receiver is further configured to receive an access token for accessing the dependent content from the authorization server in response to the authorization request sent by the transmitter, wherein the transmitter is further configured to send a second access request for the segment of the dependent content to the content server, and wherein the second access request carries the access token received by the receiver.

17. A content server, comprising:
a receiver configured to receive a first access request for a segment of depended content from a user device;
a processor coupled to the receiver and configured to generate an access receipt according to the first access request received by the receiver, wherein the access receipt contains information describing present access to the segment of the depended content by the user device; and
a transmitter coupled to the processor and configured to send the access receipt generated by the processor to the user device.

18. The content server of claim 17, wherein the information contained in the access receipt comprises information on at least one of access time, a segment number, a segment uniform resource locator (URL), a source address of the access receipt, and a destination address of the access receipt.

19. The content server of claim 17, wherein the access receipt sent by the transmitter is in a form in which any modification to the access receipt can be detected by a network side.

20. The content server of claim 19, wherein the access receipt is encrypted or signed.
